(19) United States
(12) Patent Application Publication
(10) Pub. No.: US 2006/0227180 A1
(43) Pub. Date: Oct. 12, 2006

(54) PIEZOELECTRIC VIBRATION PLATE

(76) Inventors: Chih-Chang Tsai, Kao-Hsiung City (TW); Min-Sheng Shih, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,827

(22) Filed: Jul. 12, 2005

(30) Foreign Application Priority Data
Apr. 12, 2005 (TW) 094111473

(51) Int. Cl. B41J 2/045; B41J 2/175

(52) U.S. Cl. 347/70

(57) ABSTRACT

A piezoelectric vibration plate for a print head of a piezoelectric inkjet printer includes a vibration layer, a piezoelectric layer, two electrodes and a frame. The piezoelectric layer is formed on the vibration layer. The two electrodes are formed between the vibration layer and the piezoelectric layer. The frame is disposed on the vibration layer and surrounds the piezoelectric layer for holding the piezoelectric layer in position.

### BACKGROUND OF INVENTION

1. Field of the Invention

The present invention relates to a piezoelectric vibration plate of a print head, and more particularly, to a piezoelectric vibration plate of a print head of an inkjet printer having two electrodes formed between a vibration layer and a piezoelectric layer.

2. Description of the Prior Art

With rapid development of technology, the speed and the memory size of personal computers increase and the functions of peripheral devices, such as printers, also improve accordingly. Among various types of printers, inkjet printers best match the requirements of high printing speed, high resolution, low price, low noise and long-term preservation of printing materials.

An inkjet printer ejects ink of different colors in the form of tiny ink droplets through its thermal print head onto printing materials, such as paper. The inkjet printer generates different kinds of color images by controlling the amount of color ink and the location of each ink droplet on the paper. Depending on printing technologies, there are two major types of inkjet printers: thermal bubble inkjet printers and piezoelectric printers.

The printing technology of piezoelectric printers is based on piezoelectricity. Piezoelectricity is a coupling between a material's mechanical and electrical behaviors. In the simplest of terms, when a piezoelectric material is squeezed, an electric charge collects on its surface. Conversely, when a piezoelectric material is subjected to a voltage drop, it mechanically deforms. The print head of a piezoelectric printer is similar to a piezoelectric system formed by piezoelectric materials that change dimensions according to the applied voltages. When a voltage is applied to the piezoelectric vibration plate of the print head, the piezoelectric vibration plate deforms, squeezes the ink stored in the ink chamber, and ejects the ink out of the nozzle of the print head. When the applied voltage drops, the piezoelectric vibration plate resumes its original dimensions, separating ink stored in the ink chamber from the ink droplet being ejected and refilling ink into the ink chamber by capillarity. The vibrating frequency of the piezoelectric vibration plate affects the ink ejection rate, and the size of ejected ink droplets depends on the applied voltage.

Common materials for making piezoelectric vibration plates of print heads in piezoelectric inkjet printers include metal, ceramic, high-polymeric or composite materials, each having advantages and disadvantage when used in piezoelectric inkjet printers. For example, metal materials have high reaction speed but poor deformation ability, while high-polymeric materials have good deformation ability but low reaction speed. In the prior art, piezoelectric vibration plates of piezoelectric inkjet printers are generally manufactured in a complicated and expensive process called a “co-fired” process. Therefore, the low yield and high cost of this process are major drawbacks of the prior art technique.

Please refer to FIG. 1 for a prior art piezoelectric vibration plate 10. The piezoelectric vibration plate 10 comprises a vibration layer 12, a piezoelectric layer 14, an upper electrode 16 and a lower electrode 18. The piezoelectric vibration plate 10 is manufactured in a ceramic co-fired process. Simply speaking, in a ceramic co-fired process, multiple layers are combined by co-firing under high temperature and high pressure. Piezoelectric printers with print heads manufactured in the ceramic co-fired process have the following drawbacks:

(1) Print heads of piezoelectric printers have very small dimensions and delicate structures. Extremely precise alignment between multiple layers in the ceramic co-fired process is required before the final co-firing combination. The complexity and difficulty of the ceramic co-fired process reduces the manufacturing yield of print heads.

(2) Due to the complicated structures of the print heads, each layer of the piezoelectric vibration plates can suffer unbalanced deformation during the high-temperature and high-pressure combination and can thus influence the integrity of the entire print head structure.

(3) The unbalanced deformation mention in drawback (2) also results in mismatches between different layers of the piezoelectric vibration plates. Theses mismatches not only lower the manufacturing yield of the print heads, they also impact the compactness of the print heads, and thus lower the printing resolution of the piezoelectric printers.

The prior art piezoelectric vibration plate 10 is manufactured in a ceramic co-fired process that is costly, complicated and suffers low production yield. Also, the prior art piezoelectric vibration plate 10 cannot achieve high deformation ability and high reaction speed at the same time.

### SUMMARY OF INVENTION

It is therefore a primary objective of the claimed invention to provide a piezoelectric vibration plate to solve the above-mentioned problems.

Briefly described, the present invention discloses a piezoelectric vibration plate comprising a vibration layer, a piezoelectric layer formed on the vibration layer, and two electrodes formed between the vibration layer and the piezoelectric layer.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a prior art piezoelectric vibration plate.

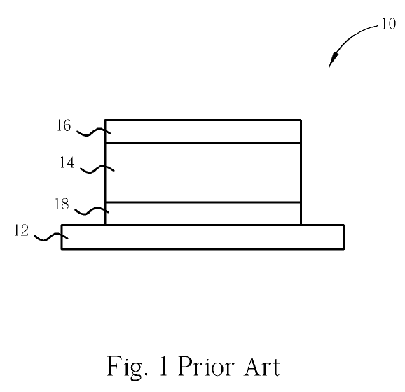

FIG. 2 shows a piezoelectric vibration plate according to the present invention.

FIG. 3 shows another piezoelectric vibration plate according to the present invention.

### DETAILED DESCRIPTION

In the present invention, high-polymeric materials having high deformation ability are used for a vibration layer, and two electrodes are formed on the vibration layer in the same process. The high reaction rate of the two electrodes can compensate for the low reaction rate of the high-polymeric materials.

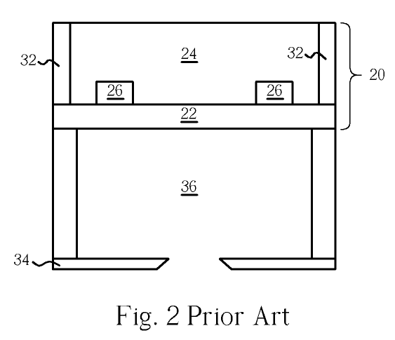

Please refer to FIG. 2 for a piezoelectric vibration plate 20 according to the present invention. The piezoelectric vibration plate 20 comprises a vibration layer 22, a piezoelectric layer 24, two electrodes 26 and a frame 32. The piezoelectric layer 24 is formed on the vibration layer 22. The two electrodes 26 are formed between the vibration layer 22 and the piezoelectric layer 24. The piezoelectric vibration plate 20 is disposed on a nozzle plate 34 and forms a cavity structure 36 with the nozzle plate 34. The cavity structure 36 serves as an ink chamber for storing ink. The frame 32 is disposed on the vibration layer 22 and surrounds the piezoelectric layer 24 for holding the piezoelectric layer 24 in position. The piezoelectric layer 24 can include ceramic materials, such as lead zirconate titanate (PZT) or poly-vinylidene fluoride (PVDF). The vibration layer 22 can include high-polymeric materials, such as polyimide. The frame 32 can include polyimide.

By controlling voltages applied to the two electrodes 26, the piezoelectric vibration plate 20 controls the ejection of ink stored in the ink chamber. The piezoelectric layer 24 exhibits piezoelectric behaviors and deforms according to voltages applied to it. When a control voltage is applied to the piezoelectric layer 24 through the two electrodes 26, the piezoelectric layer 24 expands and pushes the vibration layer 22 toward the nozzle plate 34 for ejecting ink. When the control voltage stops, the piezoelectric layer 24 resumes its original dimensions, pulling the vibration layer 22 back and drawing ink into the ink chamber.

The purity and size of ejected ink droplets and the printing speed are main factors for rating ink jet printers, and these factors not only depend on the precise control of applied voltages, but also on the reaction rate of the vibration layer 22. The failure of responding to an applied voltage in time unavoidably influences the printing quality of the inkjet printer. Also, if the vibration layer 22 has poor deformation ability, it cannot provide the pressure and the speed required for ejecting ink. Unlike the prior art piezoelectric vibration plate 10 with the upper electrode 16 and the lower electrode 18, in the piezoelectric vibration plate 20 of the present invention, two electrodes 26 are formed on the vibration layer 22 comprising high-polymeric materials, such as polyimide. Therefore, the two electrodes 26 formed above the vibration layer 22 can compensate the low reaction speed of the vibration layer 22. Unlike the prior art piezoelectric vibration plate 10 that requires two processes for forming the upper electrode 16 and the lower electrode 18, the two electrodes 26 of the present invention can be formed in the same process. The present invention piezoelectric vibration plate 20 features high deformation performance and high reaction speed, and can be manufactured in a simpler process.

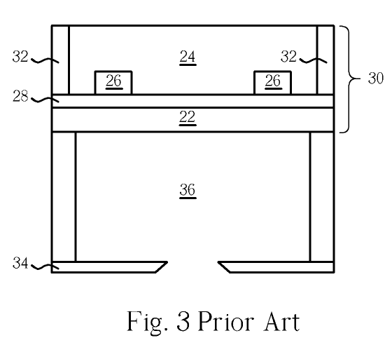

Please refer to FIG. 3 for another piezoelectric vibration plate 30 according to the present invention. The piezoelectric vibration plate 30 comprises a vibration layer 22, a piezoelectric layer 24, two electrodes 26, a connection layer 28 and a frame 32. The piezoelectric vibration plate 30 differs from the piezoelectric vibration plate 20 in that the piezoelectric vibration plate 30 further comprises the connection layer 28. The connection layer 28 is formed on the vibration layer 22 for holding the two electrodes 26 and the frame 32 on the vibration layer 22. The piezoelectric layer 24 is formed on the connection layer 28. The two electrodes 26 are formed between the connection layer 28 and the piezoelectric layer 24. The piezoelectric vibration plate 30 is disposed on a nozzle plate 34 and forms a cavity structure 36 with the nozzle plate 34.

The present invention solves the problems encountered in the prior art ceramic co-fired process by forming the two electrodes 26 between the vibration layer 22 and the piezoelectric layer in the same process. Therefore, the present invention does not require the expensive and complicated ceramic co-fired process, and does not suffer from defects caused by the high-temperature and high-pressure co-firing processes. Also, by forming the two electrodes 26 between the vibration layer 22 and the piezoelectric layer in the same process, the present invention not only simplifies the manufacturing process, but two electrodes 26 also compensate the low reaction speed of the high polymeric vibration layer 22. In conclusion, the present invention provides a piezoelectric vibration plate for the print head of a thermal bubble printer that has high deformation ability and high reaction rate, and can be manufactured in a simple process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A piezoelectric vibration plate comprising:
a vibration layer;
a piezoelectric layer formed on the vibration layer; and
two electrodes formed between the vibration layer and the piezoelectric layer.

2. The piezoelectric vibration plate of claim 1 further comprising a frame disposed on the vibration layer and surrounding the piezoelectric layer.

3. The piezoelectric vibration plate of claim 2 further comprising a connection layer formed on the vibration layer for holding the two electrodes and the frame on the vibration layer.

4. The piezoelectric vibration plate of claim 2 wherein the frame comprises polyimide.

5. The piezoelectric vibration plate of claim 1 wherein the vibration layer comprises polyimide.

6. The piezoelectric vibration plate of claim 1 wherein the piezoelectric layer comprises lead zirconate titanate (PZT).

7. The piezoelectric vibration plate of claim 1 wherein the piezoelectric layer comprises poly-vinylidene fluoride (PVDF).

8. The piezoelectric vibration plate of claim 1 wherein the vibration layer is disposed on a nozzle plate and forms a cavity structure with the nozzle plate.
